(19) United States
(12) Patent Application Publication
(10) Pub. No.: US 2004/0139015 A1
(43) Pub. Date: Jul. 15, 2004

(54) Method for preparing a payment transaction in a communication network

(76) Inventor: Karsten Luttge, Berlin (DE)

Correspondence Address: MORRISON & FOERSTER LLP, 1650 TYSONS BOULEVARD, SUITE 300, MCLEAN, VA, 22102, US

(21) Appl. No.: 10/686,523

(22) Filed: Oct. 16, 2003

(30) Foreign Application Priority Data
Oct. 18, 2002 (DE) 10249612.9

(51) Int. Cl. G06F 17/60

(52) U.S. Cl. 705/40

(57) ABSTRACT

A method for preparing a payment transaction using a communication terminal associated with a payer and a receiver terminal associated with a payee. The communication terminal is associated with a first payment system in a first communication network and the receiver terminal is associated with a second payment system. In this case, a payment request message relating to the payer from the receiver terminal prompts the second payment system to create authorization data associated with the payment request message and to send them to the receiver terminal. The receiver terminal transmits a further payment request message together with the authorization data to the first payment system. The first payment system uses the authorization data to check whether the payee is authorized to participate in the payment transaction, and if appropriate the first payment system transmits a guarantee data record guaranteeing payment by the payer to the receiver terminal.

### CLAIM FOR PRIORITY

This application claims priority to German Application No. 10249612.9 filed Oct. 18, 2002, which is incorporated herein, in its entirety, by reference.

### TECHNICAL FIELD OF THE INVENTION

The invention relates to a method for preparing a payment transaction using a first communication network.

### BACKGROUND OF THE INVENTION

In “electronic commerce” (e-commerce), for example, it is necessary to perform payment transactions using communication networks. By way of example, such payment transactions can arise when chargeable services (e.g. supply of information, data or goods) are provided over the communication networks. Examples of such communication networks used are the Internet, telephone landline networks or second and third generation mobile radio networks. In order to pay for the services, by way of example, methods for cashless payment using a mobile terminal (e.g. a mobile telephone, a laptop, a PDA (Personal Digital Assistant) or a palmtop) and/or an Internet terminal (e.g. an Internet computer) are required. However, methods for payment over communication networks are also required outside of electronic commerce and independently of the provision of services, for example for donations.

In some cases, payees do not perform the relatively complex payment transactions themselves, but rather make use of “payment service providers” which operate payment systems for handling payment transactions. Such payment transactions thus sometimes involve a payer (e.g. a customer, consumer), a payee (e.g. a trader, service provider, merchant) and a payment system associated with the payment service provider, with both the payer and the payee making use of the services of the payment service provider or of the payment system.

### SUMMARY OF THE INVENTION

The present invention discloses a method which can be used in a simple and reliable manner to prepare payment transactions using a communication terminal associated with a payer and a receiver terminal associated with a payee even when the terminals of the payer and of the payee are associated with different payment systems.

In one embodiment of the invention, there is a method for preparing a payment transaction using a communication terminal associated with a payer and a receiver terminal associated with a payee, where the communication terminal is associated with a first payment system in a first communication network and the receiver terminal is associated with a second payment system, in which a payment request message relating to the payer from the receiver terminal prompts the second payment system to create authorization data associated with the payment request message and to send them to the receiver terminal, the receiver terminal transmits a further payment request message together with the authorization data to the first payment system, the first payment system uses the authorization data to check whether the payee is authorized to participate in the payment transaction, and if appropriate then the first payment system transmits a guarantee data record guaranteeing payment by the payer to the receiver terminal.

In another embodiment of the invention, the second payment system uses the payment request message to ascertain the first payment system which is to be used for the payment transaction and sends identification data for this first payment system together with the authorization data to the receiver terminal, and the receiver terminal uses the identification data to transmit the further payment request message and the authorization data to the first payment system. This means that the invention can advantageously be carried out even if the first payment system used by the payer is not known to the receiver terminal from the outset.

In still another embodiment, the further payment request message prompts the first payment system to output a data message prompting clearing of cash resources (financial clearing of the payment transaction) between the payer and a payment service provider for the first payment system.

In yet another embodiment, the receiver terminal transmits the guarantee data record to the second payment system and then the second payment system outputs a further data message prompting clearing of cash resources between the payee and a second payment service provider for the second payment system.

In another embodiment of the invention, one of the payment systems outputs a third data message prompting clearing of cash resources between the first payment service provider for the first payment system and the second payment service provider for the second payment system.

In still another embodiment of the invention, a digital signature is transmitted to the receiver terminal as authorization data.

In yet another embodiment of the invention, information relating to a payment sum which is to be paid to the payee by the payer is transmitted to the receiver terminal with the guarantee data record. This guarantees the payee payment of this payment sum by the payer.

In another embodiment, the first payment system precedes transmission of the guarantee data record to the receiver terminal by performing a difference formation in which the payment sum is reduced by an amount which is incurred for use of the first payment system.

In still another embodiment, the first payment system and the second payment system are used to prepare a payment transaction across payment systems.

In yet another embodiment, the second payment system is associated with a second communication network, and the first payment system and the second payment system are used to prepare a payment transaction across communication networks.

### BRIEF DESCRIPTION OF THE DRAWINGS

The invention is explained in more detail below with reference to exemplary embodiments of the invention illustrated in the figures, in which:

FIG. 1 shows an arrangement for carrying out the inventive method.

FIG. 2 shows an exemplary embodiment of method in the inventive method.

FIG. 3 shows an exemplary embodiment of the method in the inventive method.

### DETAILED DESCRIPTION OF THE INVENTION

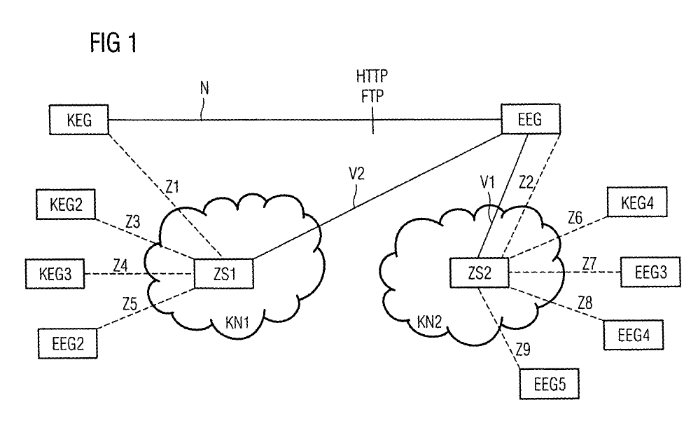

FIG. 1 shows a communication terminal KEG associated with a payer, the communication terminal being associated with a first payment system ZS1 in a first communication network KN1. The association is shown symbolically by a dashed line Z1. The first payment system ZS1 is operated by a first “payment service provider” (PSP) (associated with a payer or customer) and in this exemplary embodiment forms part of the first communication network KN1. However, the first payment system ZS1 can equally well be arranged outside the first communication network KN1 and can be connected thereto by means of an OSA gateway, for example. The first payment system ZS1 has further communication terminals KEG2 and KEG3 associated with it (associations Z3 and Z4). The right-hand side of FIG. 1 shows a receiver terminal EEG associated with a payee, the receiver terminal being associated with a second payment system ZS2 in a second communication network KN2 (association Z2). The second payment system ZS2 is associated with a second payment service provider, with this second payment service provider providing services for the payee or trader. (In another exemplary embodiment, this second payment system can alternatively be associated with the first payment service provider, for example, which also operates the first payment system ZS1.) The second payment system ZS2 also has a further communication terminal KEG4 associated with it; the second payment system ZS2 likewise has further receiver terminals EEG3, EEG4 and EEG5 associated with it (associations Z7, Z8 and Z9). Such a further receiver terminal EEG2 is also associated with the first payment system ZS1 (association Z5). The payer's communication terminal KEG uses a user channel N to request a service or goods from the payee's receiver terminal EEG. The user channel N can be provided using data links or suitable communication protocols, e.g. using HTTP (hypertext transfer protocol) or FTP (file transfer protocol). Alternatively, the user channel N can be provided by a simple telephone link or other audible voice signal transmission between payer and payee. In the subsequent course of the method, a first link V1 (for example a communication link, data link) can be set up from the receiver terminal EEG to the second payment system ZS2, which is associated with the payee. Likewise, a second link V2 can be set up from the receiver terminal to the first payment system ZS1, which is associated with the payer.

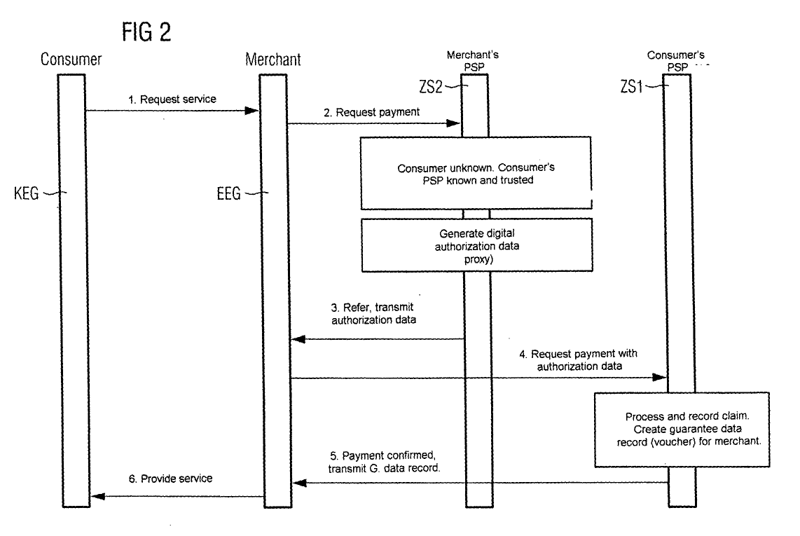

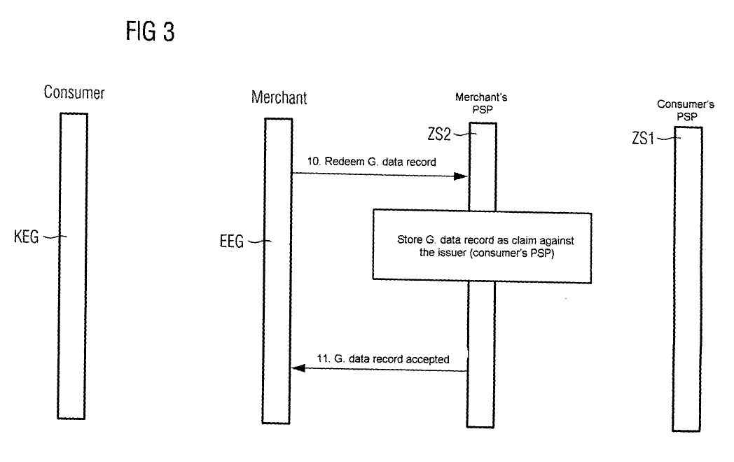

The same communication protocols can be used for the first link V1 and the second link V2. For these two virtual links, it is possible to use already existing communication protocols, such as “Parlay content based charging”, with slight extensions (for example using previously unused data fields for additional data which are to be transmitted) being made if appropriate. To carry out the inventive method, there is thus advantageously no need for a new communication link to be set up between the first payment system ZS1 and the second payment system ZS2, and therefore no new communication protocol needs to be used between the two either. It is merely necessary to ensure that authorization data generated by the second payment system ZS2 (cf. the explanations given below in connection with FIG. 2) are accepted by the first payment system ZS1. This can easily be achieved by an agreement made between the payment systems' payment service providers in advance or by extending an existing roaming agreement. Setup of the links V1 and V2 is explained in detail below with reference to FIGS. 2 and 3. FIG. 1 shows the case in which the two payment systems are in different communication networks, and therefore a payment transaction is prepared not just across payment systems (involving a plurality of payment service providers) but even across communication networks.

FIG. 2 shows the method taking place in the individual terminals and payment systems. The left-hand side of FIG. 2 shows the communication terminal KEG, which is associated with or operated by a customer (consumer). Shown next to it on the right is the receiver terminal EEG of a trader (merchant). Next to that on the right in symbol form is the second payment system ZS2, which is operated by a payment service provider PSP associated with the trader. The right-hand side of FIG. 2 shows the first payment system ZS1, which is operated by another payment service provider, namely the customer's payment service provider, and is thus associated with this customer.

First, the customer uses the communication terminal KEG to make contact with the trader's receiver terminal EEG in order to use a service. This involves a service request message 1 (arrow 1. “Request service”) being sent from the communication terminal of the customer (the payer) to the receiver terminal of the trader (the payee). The customer has already been presented in advance with a service selection (not shown in the picture) on his communication terminal KEG, the communication terminal KEG is used to select goods or a service and to request them/it for delivery via the user channel N (cf. FIG. 1). Before delivery of the goods or service, however, the trader needs to have ensured that these goods or this service will also be paid for by the customer. Therefore, the payee's receiver terminal EEG sends a payment request message 2 relating to the payer (arrow 2. “Request payment”) to the second payment system ZS2 via the first link V1 (cf. FIG. 1). The second payment system ZS2 checks in a database (not shown in FIG. 2) whether an agreement has been made between the second payment system ZS2 and the customer to which the payment request message relates. In this exemplary embodiment, the second payment system ZS2 obtains from the database the information that no agreement has been made with the customer (“consumer unknown”). This means that the second payment system ZS2 cannot perform a payment transaction with the customer, that is to say it cannot settle the payment request directly. From the database, the second payment system ZS2 also reads the information that the customer or his communication terminal KEG is associated with the first payment system ZS1. The database likewise stores the information that there is trust between the first payment system ZS1 or the customer's payment service provider and the second payment system ZS2 or the trader's payment service provider (“consumer's PSP known and trusted”). Such trust can be based, by way of example, on previously made agreements or long-term business relationships. This means that the two payment systems ZS1 and ZS2 mutually accept payments and messages relating to payments or payment transactions from the respective other payment system. The second payment system ZS2 then generates authorization data (“Generate digital authorization data (proxy)”) which are associated with the payment request message 2. Such authorization data can also be understood as a “digital proxy”. By way of example, these authorization data contain a selection of the following information:

identity of the second payment system ZS2 or of the payment service provider operating this second payment system,

identity of the trader,

identity of the first payment system ZS1 or of the customer's payment service provider operating this payment system,

identity of the customer,

expiry date for the validity of the authorization data.

In addition, the authorization data can include information which are significant to the payment system ZS1, such as charges for performing the payment transaction, which are levied by the second payment system for handling the payment transaction, or a maximum permissible payment claim level. The second payment system ZS2 signs the authorization data and does so using, by way of example, a private key from an inherently known asymmetrical signing method, i.e. a signing method which is carried out using a private (secret) key and a public (non-secret) key. The second payment system ZS2 then sends a referral message (arrow 3. “Refer, transmit authorization data”) to the trader's receiver terminal EEG, the referral message being used to send the receiver terminal the information that the payment transaction cannot be performed directly with the respective payer (customer). The receiver terminal is likewise sent the information that the first payment system ZS1, which is responsible for payments with the customer, is known. At the same time, the receiver terminal is sent identification data for this first payment system (e.g. an address for the first payment system ZS1 or for the payment service provider). This is because such identification data are likewise stored in the aforementioned database and are read from this database by the second payment system ZS2. The referral message 3 is also used to transmit the authorization data to the receiver terminal EEG. The receiver terminal EEG then uses the identification data obtained to send a further payment request message (arrow 4. “Request payment with authorization data”) together with the authorization data to the first payment system ZS1. This data transmission is effected using the second link V2 (cf. FIG. 1). The first payment system ZS1 then checks the authorization data for one or more of the following criteria:

Authenticity, i.e. have the authorization data (the proxy) really been issued by the payment service provider indicated as the issuing payment service provider? To carry out this check, the signature is checked using the issuing payment service provider's public key.

Integrity, i.e. have the authorization data not been altered following creation? This is likewise checked using the authorization data's signature.

Are the authorization data intended for the first payment system ZS1?

Has an agreement been made between the first payment system ZS1 and the second payment system ZS2, i.e. can the first payment system ZS1 settle claims with the second payment system ZS2?

Are the authorization data valid for the customer to which the further payment request message relates?

Have the authorization data not yet expired, i.e. has the validity date not yet been passed?

On the basis of the aforementioned agreement made between the payment systems or the associated payment service providers, it is also possible to check whether the issuing payment service provider has limited the claim level or whether he claims charges for performing the payment transaction. These charges can be transferred to the customer, for example, i.e. the customer's payment service provider will use his first payment system ZS1 to claim a greater payment sum from the customer than the trader originally demanded in the payment request message 2.

In another exemplary embodiment of the invention, the authorization data themselves can also be formed by a digital signature. In this case, the second payment system ZS2 calculates this signature from such information data as were both included in the first payment request message and are also sent later to the first payment system using the further payment request message. This signature is then transmitted to the first payment system ZS1 as authorization data together with the further payment request message. The first payment system can use the signature to check whether the receiver terminal has used the further payment request message for actually transmitting the information data for which the second payment system ZS2 granted the authorization data or created the signature. Alternatively, the authorization data can also be formed by a transaction number which is valid just for a single payment transaction.

If, in the first exemplary embodiment mentioned, the check on the authorization data (or in the further exemplary embodiment the check on the information data transmitted with the further payment request message using the authorization data in the form of the digital signature) has concluded with a positive check result (that is to say the authorization data or the information data have been established as being correct), the first payment system ZS1 can optionally carry out further checks and actions relating to the payment transaction. To this end, by way of example, it can check the customer's credit rating by checking an appropriate database or can interactively get the customer's consent. These operations are not shown in FIG. 2. Following successful conclusion of the check, the first payment system ZS1 creates a guarantee data record (“Process and record claim. Create data record (voucher) for merchant”), which is a digital “voucher” for the trader, the guarantee data record containing the following information:

level of the payment amount for which the first payment system ZS1 guarantees payment to the payer,

payee for whom the guarantee data record has been issued,

payer for whom the service has been provided,

payment system or payment service provider which issued the guarantee data record,

expiry date of the guarantee data record.

If a payment charge is incurred for use of the first payment system, then the first payment system can precede creation of the guarantee data record by performing a mathematical difference formation in which the payment sum (payment amount) is reduced by an amount corresponding to the charge.

The payer's payment service provider or the first payment system ZS1 signs the guarantee data record using his private key from an asymmetrical signing method. The relevant information about creation of this guarantee data record is recorded (stored) together with further information from the further payment request message in the first payment system ZS1 for the purpose of subsequently prompting clearing of cash resources, e.g. between the payer's payment service provider and the payee's payment service provider, in a conventional manner. The first payment system ZS1 then sends the receiver terminal EEG a message that the payment has been accepted by the payer. Together with this message, the guarantee data record is also transmitted to the receiver terminal EEG (arrow 5. “Payment confirmed, transmit guarantee data record (voucher)”. This guarantees the receiver terminal and the payee payment by the payer, that is to say the payee has the guarantee that he will receive his money during subsequent clearing of cash resources (financial clearing), during the actual payment transaction. Accordingly, the payee can now use his receiver terminal to provide the service (arrow 6. “Provide service”), that is to say, by way of example, can transmit the data requested using the service request message 1 to the payer's communication terminal. This method thus ensures that the payer receives his remuneration for using the service during the clearing of cash resources (which does not have to take place immediately, but rather can advantageously take place later, e.g. at the end of a predetermined billing period, using conventional means of cash transfer).

FIG. 3 shows the method in invention. When the guarantee data record has arrived on the receiver terminal EEG, this receiver terminal EEG can transmit the guarantee data record to the second payment system ZS2 (the “voucher” can be redeemed, so to speak). This is shown in FIG. 3 using the arrow 10. (“Redeem guarantee data record”). This data transmission 10 can take place immediately after the guarantee data record has arrived on the receiver terminal (that is to say while the service is actually being provided 6, for example) or else at a later time. When choosing the time, however, it should be ensured that the guarantee data record's expiry time has not yet been passed. This can be done, by way of example, by regularly redeeming all vouchers which have arrived whenever predetermined time periods have elapsed. It is advantageous, for example, if the receiver terminal collects the guarantee data record vouchers which have arrived in the course of a day and transmits these data records to the second payment system ZS2 at night, i.e. at times of low traffic. The time at which the messages are transmitted can be stipulated, in particular, in an agreement between the trader and the payment service provider for the second payment system ZS2. In this manner, it is possible to influence the utilization level of the second payment system ZS2 positively by achieving an even utilization level both during the day and at night.

One advantage of the invention is that the data records do not have to be redeemed in the second payment system in real time, that is to say there are no real-time requirements for redemption. The result of this is a method which is particularly simple to carry out, which is also reflected in low method costs.

When the guarantee data record 10 is transmitted, the trader's receiver terminal notifies the second payment system of what claims from the trader result from provision of the service. The second payment system ZS2 will financially clear this claim with the trader at a later time. The second payment system ZS2 stores the guarantee data record (voucher); this voucher includes information relating to a financial claim against the issuer of the guarantee data record, that is to say against the first payment system ZS1 or against its payment service provider. This claim will likewise be cleared when an appropriate billing period has elapsed, for example. The claims can then be cleared using cash transaction means which are in general used today, for example by means of cash transfer, sending a check or debiting a credit card. Both the first payment system ZS1 and the second payment system ZS2 respectively prompt such financial clearing transactions by issuing a corresponding data message and transmitting it, by way of example, to a transaction computer in a “clearing house”, a bank or a credit card organization. In this manner, financial clearing of the payment transaction between the payer and the first payment system's first payment service provider, between the payee and the second payment system's second payment service provider, and between the first payment service provider and the second payment service provider is prompted at a later time if appropriate.

Before these financial clearing transactions take place, however, the second payment system ZS2 checks the guarantee data record to determine whether it is valid.

This can specifically involve checking:

The originality of the guarantee data record: does the issuer stated in the guarantee data record match the signature generator? This is checked using the issuer's public key, by using the asymmetrical signing method.

Integrity: has the guarantee data record not been altered following signing?

Does the trader whose receiver terminal is transmitting the guarantee data record (that is to say the trader who is redeeming the “voucher”) match the trader stated in the guarantee data record?

Does the claimed amount correspond to the upper limits which the trader's payment service provider and the customer's payment service provider have agreed, for example contractually, for such data records?

Has the guarantee data record's validity period not yet expired?

If these checks have been successfully completed, the second payment system ZS2 accepts the guarantee data record and stores—as already mentioned above—the information transmitted with the guarantee data record for later financial clearing (a “clearing method”). The second payment system ZS2 then returns an acceptance message 11 to the receiver terminal EEG; the acceptance message is used to inform the payee about acceptance of the guarantee data record, that is to say acceptance of the voucher (arrow 11. “Guarantee data record accepted”).

The trader's payment service provider thus stores the amount stated in the guarantee data record as a claim from the trader against the trader's payment service provider. In addition, the trader's payment service provider stores the same amount as a claim against the customer's payment service provider. These claims are cleared, by way of example, at the end of a respectively agreed billing period. When the customer's payment service provider has also cleared his claim against the customer, the payment transaction is complete.

One advantage of the invention is that the messages relating to redemption of the guarantee data record do not have to be transmitted to the second payment system ZS2 in real time, and response messages from the second payment system ZS2 also do not have to be transmitted to the trader's receiver terminal in real time. Instead, these messages can be transmitted at a later, freely selectable time, since the operations of redeeming the guarantee data record, controlling the guarantee data record through the second payment system ZS2 and transferring the guarantee data record acceptance message to the receiver terminal can take place at a freely selectable time. This also relieves the load on the second payment system, which can be designed for a lower data throughput per unit time, so that this second payment system ZS2 can be implemented with comparatively little hardware complexity and hence also cost-effectively. It is likewise advantageous that the method for preparing a payment transaction does not require direct communication between the first payment system ZS1 and the second payment system ZS2.

If the two communication networks KN1 and KN2 are formed by mobile radio networks and the payment service provider for the first payment system ZS1 and the payment service provider for the second payment system ZS2 are mobile radio providers at the same time, then it is advantageously possible to revert to TAP procedures, already known as such, for the payment transaction's financial clearing transactions described above. Such TAP procedures are normally used to settle roaming charges.

In line with the invention, TAP records, which are known per se and can thus be used without any great changes to the communication networks, can be used for financial clearing of the payment transaction (e.g. in a “clearing house”). In that case, the trader's payment service provider treats the claims corresponding to the trader's redeemed voucher as though the customer in the mobile radio network associated with the trader's payment service provider (that is to say in the case of this mobile radio network's mobile radio provider) had conducted mobile telephone calls to the corresponding value.

Another advantage of the invention is that the trader's receiver terminal merely needs to be able, at the start of the method, to communicate with the second payment system ZS2 (that is to say with its associated payment system). For its part, the second payment system ZS2 then ascertains the first payment system ZS1, which is to continue to be used for the payment transaction, and sends identification data for the first payment system ZS1 together with the authorization data to the receiver terminal. This allows the receiver terminal to perform communication processes with the first payment system ZS1 subsequently as well. However, the receiver terminal does not need to know the identification data for the first payment system ZS1 in advance. The receiver terminal also does not need to register with the first payment system ZS1 in advance. The receiver terminal EEG merely needs to register once with the second payment system ZS2, which means that the method takes on a very simple form for the individual trader. Nevertheless, the trader's receiver terminal also allows him to perform payment transactions with customers who have registered with other payment systems.

In the invention, the trader transmits his claims against the customer directly to the customer's first payment system ZS1 using his receiver terminal. However, the receiver terminal or the trader does not need to register with the first payment system ZS1, because the trader's receiver terminal can use the authorization data (the digital proxy) to identify itself as trustworthy to the customer's first payment system ZS1. These authorization data are created by the trader's second payment system ZS2. So that the customer's first payment system ZS1 recognizes these authorization data, there must be “trust” between the first payment system ZS1 and the second payment system ZS2. Such trust can be based on a previously made agreement, with both the first payment system ZS1 and the second payment system ZS2 having stored information about the trust which exists in corresponding databases.

Another feature of the invention is that the customer's first payment system ZS1 creates a guarantee data record (a digital voucher) about the trader's claim against the customer, that is to say about the payee's claim against the payer, and sends this voucher to the trader's receiver terminal. The trader's receiver terminal can redeem this guarantee data record in the trader's second payment system ZS2 at a later time. The trader's second payment system ZS2 can then settle this guarantee data record with the customer's first payment system ZS1 at a later time, i.e. can carry out financial clearing of the payment transaction, known as “clearing”. The inventive use of the guarantee data record allows the payment transaction to be prepared even though the trader's receiver terminal cannot directly settle with the customer's second payment system ZS2, and hence it is also not possible to create from the payment transaction a direct trader claim against the customer's first payment system ZS1.

What is claimed is:

1. A method for preparing a payment transaction using a communication terminal associated with a payer and a receiver terminal associated with a payee, where the communication terminal is associated with a first payment system in a first communication network and the receiver terminal is associated with a second payment system, comprising:
prompting, via a payment request message relating to the payer from the receiver terminal, the second payment system to create authorization data associated with the payment request message and sending them to the receiver terminal;
transmitting, via the receiver terminal, a further payment request message together with the authorization data to the first payment system;
checking with use of the authorization data, via the first payment system, whether the payee is authorized to participate in the payment transaction; and
transmitting, when authorized, via the first payment system, a guarantee data record guaranteeing payment by the payer to the receiver terminal.

2. The method as claimed in claim 1, wherein
the second payment system uses the payment request message to ascertain the first payment system which is configured for use by the payment transaction and sends identification data for the first payment system together with the authorization data to the receiver terminal, and
the receiver terminal uses the identification data to transmit the further payment request message and the authorization data to the first payment system.

3. The method as claimed in claim 1, wherein the further payment request message prompts the first payment system to output a data message prompting clearing of cash resources between the payer and a first payment service provider for the first payment system.

4. The method as claimed in claim 1, wherein
the receiver terminal transmits the guarantee data record to the second payment system and then the second payment system outputs a further data message prompting clearing of cash resources between the payee and a second payment service provider for the second payment system.

5. The method as claimed in claim 1, wherein
one of the payment systems outputs a third data message prompting clearing of cash resources between the first payment service provider for the first payment system and the second payment service provider for the second payment system.

6. The method as claimed in claim 1, wherein a digital signature is transmitted to the receiver terminal as authorization data.

7. The method as claimed in claim 1, wherein information relating to a payment sum which is to be paid to the payee by the payer is transmitted to the receiver terminal with the guarantee data record.

8. The method as claimed in claim 7, wherein the first payment system precedes transmission of the guarantee data record to the receiver terminal by performing a difference formation in which the payment sum is reduced by an amount which is incurred for use of the first payment system.

9. The method as claimed in claim 4, wherein
the first payment system and the second payment system are used to prepare a payment transaction across payment systems.
